(19) United States
(12) Patent Application Publication
(10) Pub. No.: US 2010/0107692 A1
(43) Pub. Date: May 6, 2010

(54) Manufacturing Method and Structure of Night Glow Glass

(76) Inventor: Cheng-Wen Han, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/264,549

(22) Filed: Nov. 4, 2008

(51) Int. Cl. C03B 9/32

(52) U.S. Cl. 65/21.4

(57) ABSTRACT

A manufacturing method of a night glow glass includes the steps of manufacturing a small glass frit, combining a luminescent material, manufacturing a large glass frit, shaping a night glow glass and annealing, such that the luminescent material is wrapped in a glass wall of the night glow glass to prevent a color fade of the luminescent material and extend the expiration date of the night glow glass. The night glow glass of the invention can be applied in a table lamp, a garden lamp and a glass lamp house for various different illumination devices, or a decoration having a night glow effect.

### FIELD OF THE INVENTION

The present invention relates to a manufacturing method and a structure of a night glow glass, and more particularly to a manufacturing method and a structure of a night glow glass applied in a table lamp, a garden lamp and other illumination devices or various different designs with a night glow effect.

### BACKGROUND OF THE INVENTION

In general, conventional lamps or illumination devices come with a transparent lamp house installed at the exterior of a light emitting unit. In addition to the function of protecting the light emitting unit, the lamp house also provides various changes to give a dazzling effect for the lights produced by the light emitting units through different patterns, colors, pictures, and sandblasting skills which are applied to the surface of the lamp house to improve the quality of the lamps or the illumination devices. However, the method for a conventional glass lamp house to provide a luminescent effect is to heat and soften a glass blank first, and then place the softened glass blank on a blowing device to blow the glass blank into a glass lamp house directly, and then adhere a luminescent material (or a night glow material) onto the glass blank to combine the luminescent material onto a surface of the glass lamp house. The luminescent material combined with the surface of the glass lamp house is deteriorated or faded easily due to its contact with external air and moisture, or scratched during the manufacturing process or after the finished good is manufactured. As a result, the effect and the expiration date of the luminescent material as well as the quality of the glass lamp house will be affected adversely.

### SUMMARY OF THE INVENTION

In view of the foregoing shortcomings of the prior art, the inventor of the present invention based on years of experience in the related industry to conduct extensive researches and experiments, and finally invented a manufacturing method of a night glow glass to extend the expiration date of the luminescent material and maintain a reliable quality.

Therefore, the primary objective of the present invention is to provide a manufacturing method and a structure of a night glow glass. With a special manufacturing procedure of the night glow glass, a luminescent effect is provided in a glass wall of the night glow glass to give a special visual effect, and the night glow glass with the reliable quality can be applied extensively in various different lamps or illumination devices.

To achieve the foregoing objective, the present invention provides a manufacturing method of a night glow glass, and the manufacturing method comprises the steps of: manufacturing a small glass frit by heating and softening a glass blank; combining a luminescent material by adhering a luminescent material on a surface of the small glass frit, and heating to melt the luminescent material and combine the luminescent material with the surface of the small glass frit; manufacturing a large glass frit by adding a glass blank to a surface of the small glass frit that is combined with the luminescent material, and then covering the luminescent material to form a large glass frit; and shaping a night glow glass by adjusting the hardness of the melted large glass frit, and shaping the large glass frit to form a night glow glass, wherein a layer of luminescent material is melted in a glass wall, and the luminescent material is wrapped into the glass wall to maintain its luminescent effect and prevent deteriorations or color fades.

### BRIEF DESCRIPTION OF THE DRAWINGS

FIG. 1 is a flow chart of a manufacturing method of the present invention;

FIG. 2 is a schematic view of manufacturing a hollow small glass frit in accordance with a first preferred embodiment of the present invention;

FIG. 3 is a schematic view of combining a luminescent material in accordance with a first preferred embodiment of the present invention;

FIG. 4 is a schematic view of manufacturing a large glass frit in accordance with a first preferred embodiment of the present invention;

FIG. 5 is a schematic view of a manufacturing and blowing a hollow night glow glass in accordance with a first preferred embodiment of the present invention;

FIG. 6 is a schematic view of a night glow glass applied to a table lamp in accordance with the present invention;

FIG. 7 is a schematic view of assembling a night glow glass into a table lamp in accordance with the present invention;

FIG. 8 is a schematic view of assembling a night glow glass into a solar lamp having a luminescent effect in accordance with the present invention;

FIG. 9 is a schematic view of manufacturing a solid small glass frit in accordance with a second preferred embodiment of the present invention;

FIG. 10 is a schematic view of combining a luminescent material in accordance with a second preferred embodiment of the present invention;

FIG. 11 is a schematic view of manufacturing a large glass frit in accordance with a second preferred embodiment of the present invention; and

FIG. 12 is a schematic view of a manufacturing and blowing a solid night glow glass in accordance with a second preferred embodiment of the present invention.

### DESCRIPTION OF THE PREFERRED EMBODIMENT

To make it easier for our examiner to understand the purposes, characteristics and effects of the present invention, preferred embodiments together with related drawings are used for the detailed description of the present invention as follows:

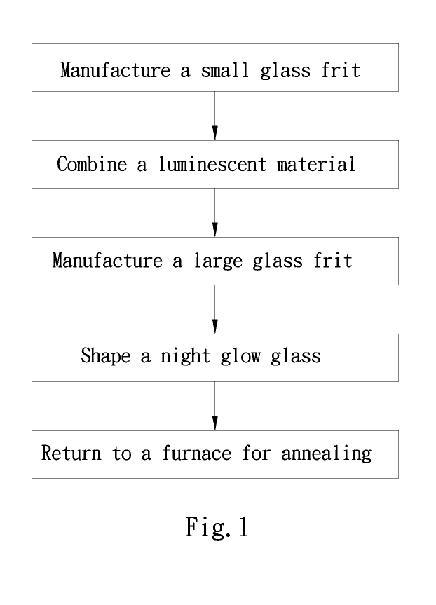

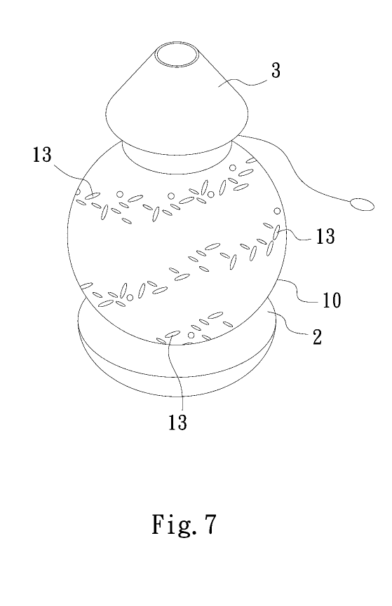

With reference to FIGS. 1 and 7 for a manufacturing method of a night glow glass in accordance with a first preferred embodiment of the present invention, a night glow glass 10 is applied to a lamp such as a table lamp, a garden lamp, a night lamp, an artistic lamp, or other illumination devices or various decorations having a night glow effect, and the night glow glass 10 is manufactured by heating and blowing a glass blank, and the manufacturing method comprises the steps of:

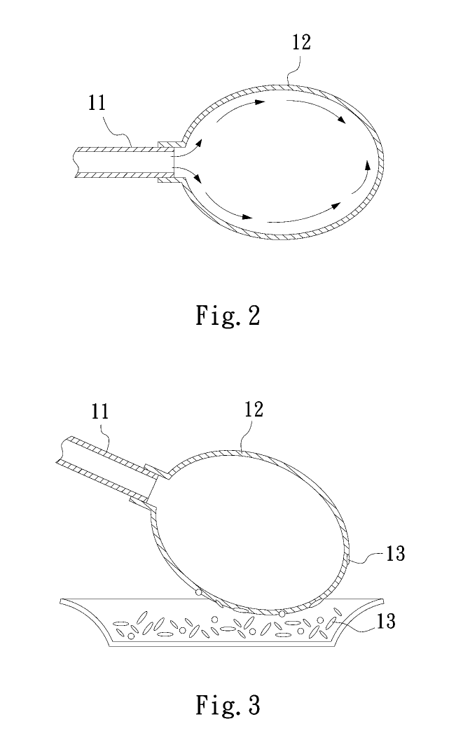

(a) Manufacturing a small glass frit by heating and softening a specific quantity of glass blank as shown in FIGS. 1 and 2, and winding the softened glass blank to an end of a blowing pipe 11, and then blowing the glass blank into a hollow small glass frit 12, wherein a large quantity of small glass frit 12 can be made in advance and prepared for the manufacturing procedure that follows.

(b) Combining a luminescent material by adhering a luminescent material 13 (or a luminescent powder) onto the whole or a part of a surface of the small glass frit 12 as shown in FIGS. 1 and 3, while adhering other color spots or materials (not shown in the figure), and then heating the small glass frit 12 to melt the luminescent material 13 and the spots, such that the luminescent material 13 and the spots are combined with the surface of the small glass frit 12, and the heating temperature falls within a range from 800° C. to 1000° C.

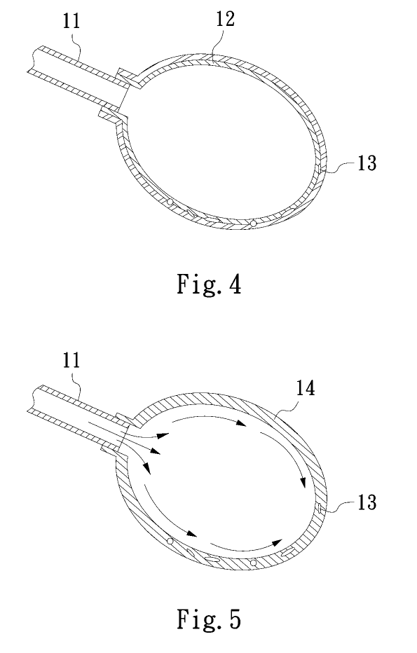

(c) Manufacturing a large glass frit by adding the heated and softened glass blank to a surface of the small glass frit 12 that is combined with the luminescent material 13 and spots as shown in FIGS. 1 and 4, and covering the luminescent material 13 and the spots by the added glass blank to form a large glass frit 14.

(d) Blowing to form a night glow glass by heating continuously to adjust the softness of the melted large glass frit 14 as shown in FIGS. 1 and 5, and then placing the large glass frit 14 into a mold, and blowing in a specific quantity of air through a blowing pipe 11 to blow the large glass frit 14 to form the night glow glass 10.

(e) Annealing by returning the finished goods of the night glow glass 10 into a furnace and heating to a specific temperature, and cooling the night glow glass 10 slowly to eliminate the stress produced during the glass manufacturing process and prevent a crack of the glass.

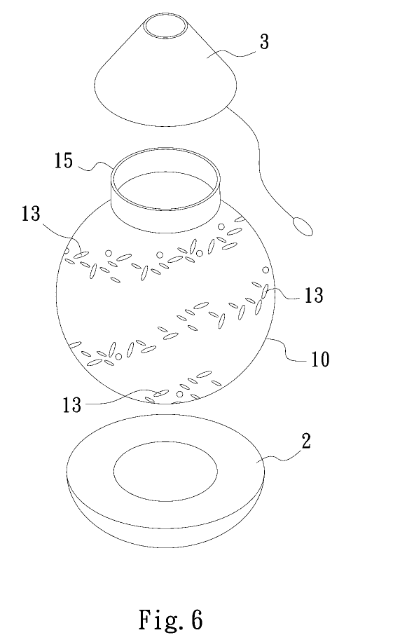

However, the foregoing steps of manufacturing the night glow glass are the main technical characteristics of the invention, but other methods can be used or added to the procedure as needed. For instance, the large glass frit 14 can be heated and softened before it is blown into a night glow glass 10, and then the large glass frit 14 is placed into a thread cutter (not shown in the figure) and turned continuously, such that the luminescent material 13 and the spots are twisted to achieve the effect of forming a spiral distribution on the surface of the large glass frit 14 (as shown in FIGS. 6 and 7). As to other repeated heating processes to maintain the small glass frit 12 or the large glass frit 14 at a soft state, these processes are necessary during the entire production process, and thus will not be described here.

A night glow glass 10 manufactured by the aforementioned manufacturing method has a transparent property and allows lights to pass through and to be refracted. The night glow glass 10 has a glass wall containing a layer of melted luminescent material 13 and spots, and the spots are distributed spirally on the glass wall of the night glow glass 10, so that a cold light can be emitted from the luminescent material 13 of the night glow glass 10 in nighttime. Particularly for applications in various different lamps or illumination devices, the luminescent material 13 can absorb the light of a light emitting unit (such as a bulb or a light emitting diode, LED) for maintaining the luminescent effect all the time. The luminescent material 13 and spots are formed in the glass wall of the night glow glass 10 and isolated from external air or moisture, so as to assure the color quality and the luminescent effect and prevent the luminescent material 13 and the spots from being scratched and falling off effectively. Obviously, the present invention has a significant improvement over the prior art.

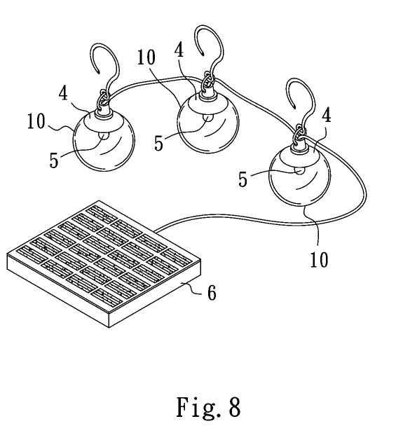

In the night glow glass 10 assembled as a lamp in accordance with the present invention, the shape can be changed as needed to fit different applications. In FIGS. 6 and 7, the night glow glass 10 is assembled into a table lamp, wherein a base 2 is combined with the bottom of the night glow glass 10, and an opening 15 disposed at the upper end of the night glow glass 10 is connected to a lamp holder 3 with a light emitting element (such as a bulb or a light emitting diode, LED) to form a table lamp. Similarly, the night glow glass 10 can be assembled into another lamp such as a solar lamp having a luminescent effect as shown in FIG. 8, and the solar lamp includes at least one LED 5 installed at a base 4, wherein the night glow glass 10 of the invention is combined with the base 4 to cover the LED 5, so that the night glow glass 10 can emit light without requiring an additional power source; and a solar cell 6 electrically coupled to the LED 5 for converting solar energy into electric energy and storing the electric energy to be supplied to the LED 5, and the night glow glass of the invention can be applied to a surface of the solar cell 6, such that after sunlight is received in daytime, the luminescent effect can be achieved in nighttime. Assembling the night glow glass 10 into a solar lamp having a luminescent effect is a feasible application of the night glow glass 10 of the invention.

With reference to FIGS. 1 and 9 to 12 for a manufacturing method of a night glow glass in accordance with a second preferred embodiment of the present invention, the night glow glass 10′ is applied to various decorations having a night glow effect, and the night glow glass 10′ is manufactured by heating and shaping a glass blank, and the manufacturing method comprises the steps of:

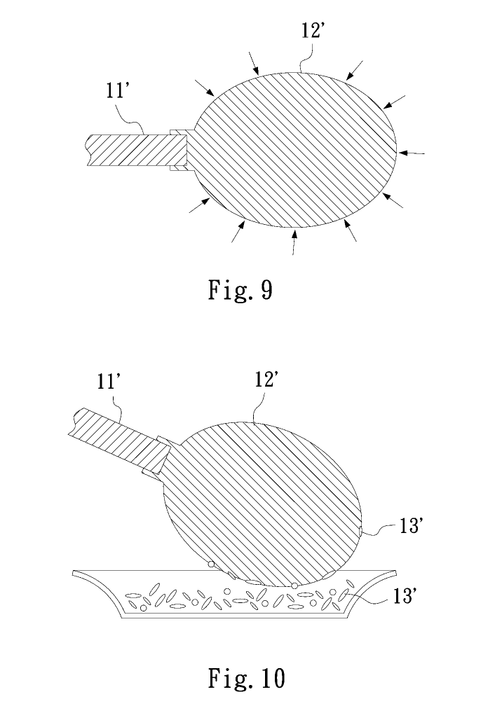

(a) Manufacturing a small glass frit by heating and softening a specific quantity of glass blank as shown in FIGS. 1 and 9, and winding the softened glass blank around a distal end of an iron pipe 11′, and then shaping and forming a solid small glass frit 12′, wherein a large quantity of small glass frits 12′ can be manufactured in advance and prepared for the manufacturing procedure that follows;

(b) Combining a luminescent material by adhering a luminescent material 13′ (or a luminescent powder) onto the whole or a part of a surface of the small glass frit 12′ as shown in FIGS. 1 and 3, while adhering other color spots or materials (not shown in the figure), and then heating the small glass frit 12′ to melt the luminescent material 13′ and the spots, such that the luminescent material 13′ and the spots are combined with the surface of the small glass frit 12′, wherein the heating temperature falls within a range from 800° C. to 1000° C.

(c) Manufacturing a large glass frit by adding the heated and softened glass blank on a surface of the small glass frit 12′ combined with the luminescent material 13′ and the spots as shown in FIGS. 1 and 11, such that the luminescent material 13′ and the spot are covered to form a large glass frit 14′ after the glass blank is added;

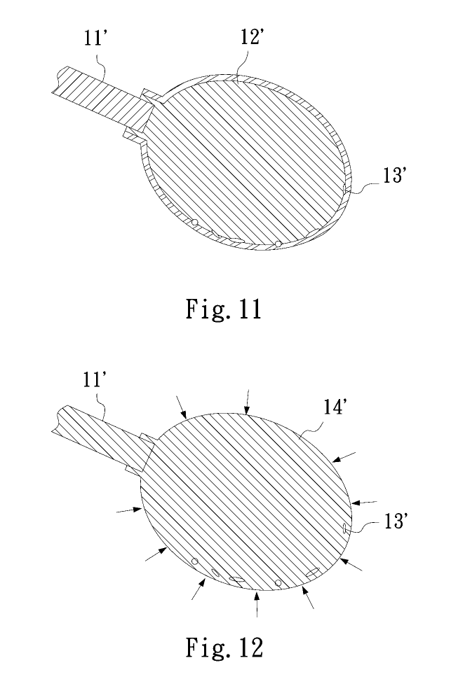

(d) Shaping to form a night glow glass by a continuous heating to adjust the softness of the melted large glass frit 14′ as shown in FIGS. 1 and 12, and then placing the large glass frit 14′ into a mold, and shaping the large glass frit 14′ to form the night glow glass 10′; and

(e) Annealing by returning the finished goods of the night glow glass 10′ into a furnace and heating to a specific temperature, and cooling the night glow glass 10′ slowly to eliminate the stress produced during the glass manufacturing process and prevent a crack of the glass.

In summation of the description above, the invention complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A manufacturing method of a night glow glass, comprising the steps of:
manufacturing a small glass frit by heating and softening a glass blank;
combining a luminescent material by adhering the luminescent material on a surface of the small glass frit, and then heating to melt and combine the luminescent material to the surface of the small glass frit;
manufacturing a large glass frit by adding a glass blank to the surface of the small glass frit which is combined with the luminescent material, and covering the luminescent material to form a large glass frit; and
shaping a night glow glass by adjusting the hardness of the melted large glass frit, and shaping the large glass frit into a night glow glass.

2. The manufacturing method of a night glow glass as recited in claim 1, wherein the step of combining the luminescent material further comprises the step of adhering a plurality of spots on a surface of the small glass frit.

3. The manufacturing method of a night glow glass as recited in claim 1, wherein the luminescent material is heated to a melting temperature falling within a range from 800° C. to 1000° C.

4. The manufacturing method of a night glow glass as recited in claim 1, wherein heating and softening the large glass frit, and putting the large glass frit into a thread cutter to produce an effect of distributing the spots spirally on the surface of the large glass frit, before shaping a night glow glass.

5. The manufacturing method of a night glow glass as recited in claim 1, further comprising an annealing step for annealing the shaped night glow glass.

6. The manufacturing method of a night glow glass as recited in claim 1, wherein the small glass frit is blown to form a hollow small glass frit, and the night glow glass is blown to form a hollow night glow glass.

7. The manufacturing method of a night glow glass as recited in claim 1, wherein the small glass frit is shaped into a solid small glass frit, and the night glow glass is shaped to form a solid night glow glass.

8. A structure of a night glow glass, comprising the night glow glass manufactured in claim 1, and the night glow glass is transparent, and a luminescent material is melted in a glass wall.

9. The structure of a night glow glass as recited in claim 8, wherein the night glow includes a plurality of spots disposed in the glass wall of the night glow glass.

10. The structure of a night glow glass as recited in claim 9, wherein the spots are spirally distributed in the glass wall of the night glow glass.
